(19) United States
(12) Patent Application Publication
(10) Pub. No.: US 2007/0227650 A1
(43) Pub. Date: Oct. 4, 2007

(54) METHOD OF MAKING MEMBRANE ELECTRODE ASSEMBLIES

(76) Inventors: Susan G. Yan, Fairport, NY (US); Michael Scozzafava, Rochester, NY (US); Zhilei (Julie) Wang, Penfield, NY (US)

Correspondence Address: HARNESS, DICKEY & PIERCE, P.L.C., P.O. BOX 828, BLOOMFIELD HILLS, MI, 48303, US

(21) Appl. No.: 11/762,103

(22) Filed: Jun. 13, 2007

Related U.S. Application Data
(62) Division of application No. 10/679,719, filed on Oct. 6, 2003.

(51) Int. Cl. B44C 1/165; B32B 7/08; B44C 1/00

(52) U.S. Cl. 156/230

(57) ABSTRACT

A method of making a membrane electrode assembly is provided. The method includes providing a non-porous polymeric substrate which has sufficient structural integrity and elastic deformation such that no significant deformations occur during processing to facilitate reuse. The substrate is optionally formed into a loop for continuous processing. A slurry is formed which includes an ionically conductive material, an electrically conductive material, a catalyst, and a high boiling point solvent. The slurry is applied onto the non-porous polymeric substrate, for example, in a pattern of discrete regions. The slurry is dried to form decals. The decals are bonded to a membrane and then the substrate is peeled from the decal in a substantially undamaged condition so that it may be reused.

### CROSS-REFERENCE TO RELATED APPLICATIONS

This application is a Divisional application of U.S. patent application Ser. No. 10/679,719 filed on Oct. 6, 2003.

### FIELD OF THE INVENTION

The present invention relates to PEM/SPE fuel cells, and more particularly to a method of making electrodes and membrane electrode assemblies.

### BACKGROUND OF THE INVENTION

Electrochemical cells are desirable for various applications, particularly when operated as fuel cells. Fuel cells have been proposed for many applications including electrical vehicular power plants to replace internal combustion engines. One fuel cell design uses a solid polymer electrolyte (SPE) membrane or proton exchange membrane (PEM), to provide ion exchange between the anode and cathode. Gaseous and liquid fuels may be used within fuel cells. Examples include hydrogen and methanol, with hydrogen being favored. Hydrogen is supplied as a reductant to the fuel cell's anode. Oxygen (as air) is an oxidant and is supplied to the cell's cathode. The electrodes are formed of electrode porous conductive materials which facilitate the electrochemical reactions in the cell. Further, electrically conductive porous diffusion media, such as woven graphite, graphitized sheets, or carbon paper facilitates dispersion of the reactants over the surface of the electrodes and hence over the membrane facing the electrode.

Important aspects of improving a fuel cell operation include optimizing the design of: the reaction surfaces where electrochemical reactions occur; catalysts which catalyze such reactions; ion conductive media; and mass transport media. The costs associated with fuel cell manufacture and operation, are in part, dependent on the cost of preparing electrodes and membrane electrode assemblies (MEA) and their operational efficiency. The costs associated with fuel cell manufacture are greater than competitive power generation alternatives, partly because of the cost of preparing such electrodes and MEAs.

Therefore, it is desirable to improve the manufacture of such assemblies by improving quality and costs to render fuel cells a more attractive alternative for power generation and transportation use.

### SUMMARY OF THE INVENTION

According to one aspect of the present invention a method useful for making a membrane electrode assembly is provided. One preferred method of making an assembly comprising an electrode comprises the following: forming a slurry comprising an ionically conductive material, an electrically conductive material, a catalyst, and a high boiling point casting solvent; applying the slurry to a non-porous polymeric substrate selected from the group consisting of: ethylene tetrafluoroethylene, polyimide, polytetrafluoroethylene, and polyphenylsulfone, the substrate having sufficient structural integrity to facilitate reuse; removing the high boiling point casting solvent to form a dried electrode film on the substrate; bonding the dried electrode to a membrane; and separating the substrate from the electrode and membrane such that the substrate may be reused.

Another preferred embodiment of a method for making an assembly comprising an electrode comprises forming a slurry comprising an ionically conductive material, an electrically conductive material, a catalyst, and a casting solvent. The slurry is applied to a non-porous polymeric substrate having sufficient structural integrity to facilitate reuse; the solvent is removed to form a catalyst film on the substrate; the decal is bonded to a membrane to form the membrane assembly electrode; and the substrate is separated from the MEA such that the substrate may be reused. The substrate is then cleaned with a cleaning solvent to remove any of the residual catalyst remaining on the substrate after the separating to form a cleaned substrate. Applying of the slurry is repeated using the cleaned substrate.

Another alternate preferred embodiment according to the present invention includes a method of fabricating an assembly comprising an electrode in a continuous process comprising: moving a continuous strip of a non-porous polymeric substrate along a feed path and forming a slurry comprising an ionically conductive material, an electrically conductive material, a catalyst, and a casting solvent at a first station along the feed path. The continuous strip of the non-porous polymeric substrate is advanced to the first station where the slurry is applied to discrete regions on a surface of the continuous strip of the non-porous polymeric substrate. The slurry is dried to form a dried catalyst layer at the discrete regions; and the continuous strip is advanced to position a membrane adjacent a respective one of the decals at the discrete regions, where bonding of at least one of the decals to the membrane to form an electrode occurs. Removal of the at least one decal from the continuous strip of the non-porous polymeric substrate follows; and the continuous strip is advanced to a cleaning station to clean the discrete regions of the surface where the electrode was removed; and the cleaned continuous strip of the substrate is advanced to the first station.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic view of an unassembled electrochemical fuel cell having a membrane electrode assembly prepared according to a preferred embodiment of the invention;

FIG. 2 is a pictorial illustration of a cross-section of a membrane electrode assembly like that illustrated in FIG. 1;

FIG. 3 is a pictorial illustration showing a magnified view of a portion of the cathode side of the membrane electrode assembly of FIG. 2;

FIG. 4 is a flow chart illustrating a preferred process according to the present invention;

FIG. 5 is a pictorial illustration showing the electrode layer upon the non-porous polymeric substrate during a step of the process of FIG. 4;

FIG. 6 is a pictorial illustration of the membrane electrode assembly showing the anode, the membrane, the cathode, and the substrate sheets during a step of the process of FIG. 4;

FIG. 7 is a pictorial illustration of a continuous process and apparatus for assembling a membrane electrode assembly according to a preferred embodiment of the present invention;

FIG. 8 shows a performance comparison of a membrane electrode assembly prepared using a porous polymeric decal substrate against a membrane electrode assembly prepared using a non-porous polymeric decal substrate at low pressure; and

FIG. 9 shows a performance comparison of a membrane electrode assembly prepared using a porous polymeric decal substrate against a membrane electrode assembly prepared using a non-porous polymeric decal substrate at high pressure.

### DETAILED DESCRIPTION OF PREFERRED EMBODIMENTS

The following description of the preferred embodiments is merely exemplary in nature and is in no way intended to limit the invention, its application, or uses. For example, although the invention is described herein with reference to a fuel cell, it is applicable to electrochemical cells generally.

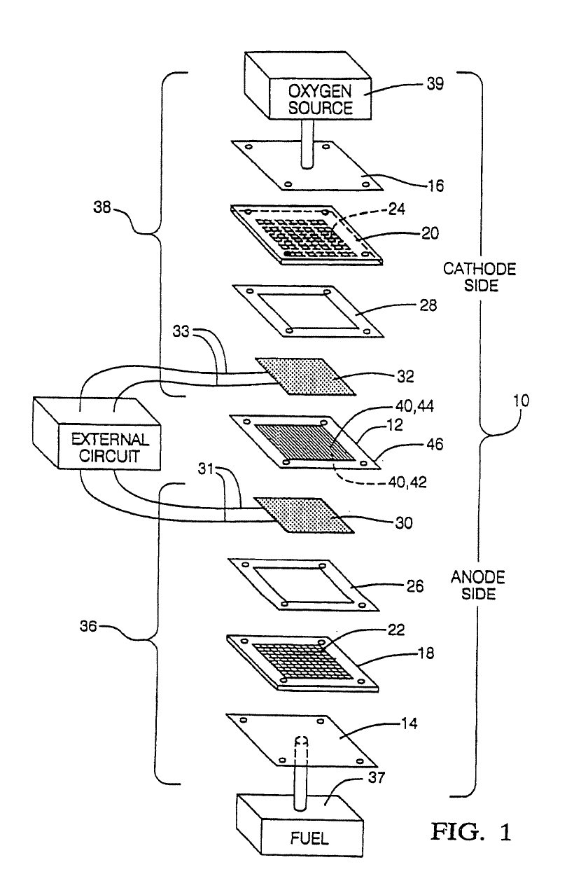

The present invention contemplates forming electrodes and membrane electrode assemblies for use in fuel cells. Before describing the invention in detail, it is useful to understand the basic elements of a fuel cell and the components of the membrane electrode assembly. Referring to FIG. 1, an electrochemical cell 10 with a membrane electrode assembly 12 incorporated therein is shown in pictorial unassembled form. The illustrated electrochemical cell 10 is constructed as a fuel cell. Electrochemical cell 10 comprises stainless steel or aluminum endplates 14, 16, bipolar gas diffusion elements or plates 18,20 with a plurality of channels 22, 24 to facilitate gas distribution, gaskets 26, 28, conductive current collector gas diffusion media 30, 32 with respective connections 31, 33 and the membrane electrode assembly 12 (including solid polymer electrolyte (SPE) or proton exchange membrane (PEM)). The two sets of bipolar plates, gaskets, and conductive current collectors, namely 18, 26, 30 and 20, 28, 32 are each referred to as respective gas and current transport means 36, 38. Anode connection 31 and cathode connection 33 are used to interconnect with an external circuit which may include other fuel cells.

Gaseous reactants are introduced into the electrochemical fuel cell 10, one of which is a fuel supplied from fuel source 37, and another is an oxidizer supplied from source 39. The gases from sources 37,39 diffuse through respective gas and current transport means 36 and 38 to opposite sides of a membrane electrode assembly (MEA) 12. As appreciated by one of skill in the art, the electrochemical fuel cell 10 can be combined with other similarly constructed fuel cells to form a multiple fuel cell stack.

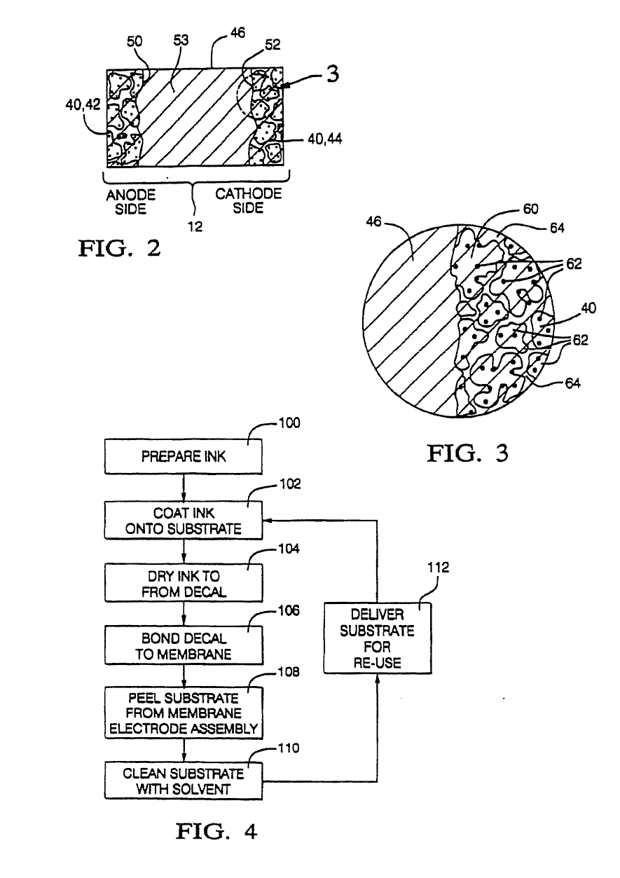

Referring to FIG. 2, the MEA 12 is prepared according to a preferred embodiment of the present invention and includes porous electrodes 40 which form an anode 42 at the fuel side and a cathode 44 at the oxygen side. Anode 42 is separated from cathode 44 by a solid polymer electrolytic (SPE) membrane 46. The membrane 46 provides for ion transport to facilitate reactions in the fuel cell 10 and is well known in the art as an ion conductive material. The electrodes 42, 44 provide proton transfer by intimate contact between the electrode 42, 44 and the ionomer membrane 46 to provide essentially continuous polymeric contact for such proton transfer. Accordingly, the MEA 12 has membrane 46 with spaced apart first and second opposed surfaces 50, 52, and a thickness or an intermediate membrane region 53 between surfaces 50, 52. Respective electrodes 40, namely anode 42 and cathode 44, are well adhered to membrane 46 at a corresponding one of the surfaces 50, 52, respectively.

The solid polymer electrolyte membranes 46, or sheets, are ion exchange resin membranes. The resins include ionic groups in their polymeric structure; one ionic component of which is fixed or retained by the polymeric matrix and at least one other ionic component being a mobile replaceable ion electrostatically associated with the fixed component. The ability of the mobile ion to be replaced under appropriate conditions with other ions imparts ion exchange characteristics to these materials.

The ion exchange resins can be prepared by polymerizing a mixture of ingredients, one of which contains an ionic constituent. One broad class of cation exchange, proton conductive resins is the so-called sulfonic acid cation exchange resin. In the sulfonic acid membranes, the cation ion exchange groups are hydrated sulfonic acid radicals which are attached to the polymer backbone by sulfonation. The formation of these ion exchange resins into membranes or sheets is also well known in the art. The preferred type is perfluorinated sulfonic acid polymer electrolyte in which the entire membrane structure has ion exchange characteristics. These membranes are commercially available, and a typical example of a commercial sulfonated perfluorocarbon, proton conductive membrane is sold by E.I. DuPont de Nemours & Co. under the trade designation Nafion®. Others are sold by Asahi Glass and Asahi Chemical Company.

In electrochemical fuel cells 10 according to the present invention, the membrane 46 known as a proton exchange membrane (PEM) is a cation permeable, proton conductive membrane, having H⁺ ions as the mobile ion; the fuel gas is hydrogen and the oxidant is oxygen or air. The overall cell reaction is the oxidation of hydrogen to form water and the respective reactions at the anode 42 and cathode 44 are as follows:
H₂→2H⁺+2e⁻
½O₂+2H⁺+2e⁻→H₂O

Typically, the product water is generated and rejected at the cathode 44 where the water typically escapes by simple flow or by evaporation. However, means may be provided if desired, for collecting the water as it is formed to carry it away from the fuel cell 10. Good water management in the cell 10 enables successful long-term operation of electrochemical fuel cell 10. Spatial variations of water content within the membrane 46 of a current-carrying fuel cell 10 result from the electro-osmotic dragging of water with proton (H⁺) transport from anode 42 to cathode 44, the production of water by the oxygen reduction reaction at the cathode 44, humidification conditions of the inlet gas stream, and “back-diffusion” of water from cathode 44 to anode 42. Water management techniques and cell designs related thereto are described in U.S. Pat. Nos. 5,272,017 and 5,316,871, each incorporated herein by reference in its entirety. Although water management is an important aspect for fuel cell 10 operation, good distribution and movement of the fuel and oxidant through the electrodes 40 is equally important. To achieve this goal it is important to have an electrode 40 with a relatively homogeneous porous structure and which has good structural integrity.

Catalyst films are formed from a dried layer(s) of a catalyst slurry as described hereinafter. Exemplary components of the MEA 12 formed by slurry casting are described in U.S. Pat. No. 6,524,736, which is herein incorporated by reference in its entirety. The catalyst film comprises carbon and catalyst, with distribution and loadings according to the requirements of the hydrogen oxidation and oxygen reduction reactions occurring in the fuel cell. In addition, effective proton transfer is provided by embedding the electrodes 40 into the membrane 46. Accordingly, the membrane electrode assembly 12 of cell 10 has a membrane 46 with spaced apart first and second opposed surfaces 50, 52, a thickness or an intermediate membrane region 53 between surfaces 50, 52. Respective electrodes 40, namely anode 42 and cathode 44, are well adhered to membrane 46 at a corresponding one of the surfaces 50, 52. The good porosity and structural integrity of electrodes 40 facilitates formation of the membrane electrode assembly 12.

As shown in FIG. 3, each of the electrodes 40 are formed of a corresponding group of finely divided carbon particles 60 supporting very finely divided catalytic particles 62 and a proton conductive material 64 intermingled with the particles. It should be noted that the carbon particles 60 forming the anode 42 may differ from the carbon particles 60 forming the cathode 44. In addition, the catalyst loading at the anode 42 may differ from the catalyst loading at the cathode 44. Although the characteristics of the carbon particles and the catalyst loading may differ for anode 42 and cathode 44, the basic structure of the two electrodes 40 is otherwise generally similar, as shown in the enlarged portion of FIG. 3 taken from FIG. 2.

In order to provide a continuous path to conduct H⁺ ions to the catalyst 62 for reaction, the proton (cation) conductive material 64 is dispersed throughout each of the electrodes 40, and is intermingled with the carbon and catalytic particles 60, 62 and is disposed in a plurality of the pores defined by the catalytic particles. Accordingly, in FIG. 3, it can be seen that the proton conductive material 64 encompasses carbon and catalytic particles 60, 62.

The carbon particles define pores some of which are internal pores in the form of holes in the carbon particles 60; other pores are gaps between adjacent carbon particles. Internal pores are also referred to as micropores which generally have an equivalent radius (size) less than about 2 nanometers (nm) or 20 angstroms. “About” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates a possible variation of up to 5% in the value. External pores are referred to as mesopores which generally have an equivalent radius (size) of over about 2 nanometers and up to about 20 nanometers or 200 angstroms. The total surface area present in a mass of carbon particles is referred to as BET surface area, expressed in m²/g. BET surface area accounts for both mesopores and micropores present in the mass. As used herein, the terms “pore” and “pores” refers to both mesopores and micropores and also refers to both internal and external pores unless otherwise indicated.

Membrane electrode assembly 12 has efficient gas movement and distribution to maximize contact between the reactants, i.e., fuel and oxidant, and the catalyst. This occurs in a porous catalyzed layer which forms the electrodes 40 and comprises particles of catalysts 62, particles of electrically conductive material 60, and particles of ionically conductive material 64. The three criteria which characterize good electrode 40 performance are gas access to the catalyst layer, electrical conductivity, and proton access to the ionomer. A typical ionomer which forms the ionically conductive material 64 is a perfluorinated sulfonic acid polymer, such as for example the Nafion® which also forms the membrane 46.

Referring to the flow chart of FIG. 4, one preferred process according to the present invention includes preparation of the catalyst slurry as indicated at 100. The catalyst slurry is often referred to as an “ink” and the terms are used interchangeably herein. The term “mixture,” as used herein, refers to a combination of substances that have been intermingled and is intended to cover either a mixture, a slurry, or a solution. The term “slurry” refers to a mixture where there is some suspended and undissolved material within a continuous fluid phase, usually a liquid phase, and the liquid in the liquid phase generally being a solvent. The term “solution” refers to a mixture where there is a solute dissolved in a solvent, thereby forming a single phase containing two or more different substances. The catalyst slurry is initially prepared as a solution of a proton conducting polymer, herein referred to as an ionomer (e.g. Nafion®), with suspended particles of electrically conductive material, typically carbon, and particles of catalyst.

The electrically conductive material, e.g., carbon, is typically the support for the catalyst which is typically a metal. Thus, the catalyst layer dispersion consists of a mixture of the precious metal catalyst supported on high surface area carbon, such as Vulcan XC-72, and an ionomer solution such as Nafion® (DuPont Fluoroproducts, NC) in a solvent. Preferred catalysts include metals such as platinum (Pt), palladium (Pd); and mixtures of metals Pt and molybdenum (Mo), Pt and cobalt (Co), Pt and ruthenium (Ru), Pt and nickel (Ni), and Pt and tin (Sn). The ionomer is typically purchased as a solution in a solvent of choice and at the desired initial concentration, and additional solvent is added to adjust the ionomer concentration to a desired concentration in the slurry. The slurry optionally contains polytetrafluoroethylene. The catalyst and catalyst support are dispersed in the slurry by techniques such as ultra-sonication or ball-milling. The average agglomerate size in a typical slurry is in the range from 50 to 500 nm. Slight variation in performance is associated with slurries made by different dispersing techniques, due to the disparity in the range of particle sizes produced.

The formation of the catalyst slurry comprises for example, 1 gram of 5 to 80 wt. % catalytically active material on carbon, for example Pt on carbon, and on the order of 8 grams of 1 to 30 wt. % ionomer in solution with a solvent. The catalyst loading, wt. % on carbon, is chosen according to the needs and requirements of a specific application. The weight ratio of ionomer to carbon is preferably in the range of 0.20:1 to 2.0:1, with a more preferred range of 0.25:1 to 1.5:1.

In the slurry, the ratio of solids to liquids is preferably in the range 0.15:1 to 0.35:1, that is, 13% to 27% by weight solids in the slurry. A more preferred range is 0.2:1 to 0.3:1 or 16% to 23% by weight of solids in the slurry. For the specifications given, the casting solvent makes up about 80% of the slurry weight, and catalyst, ionomer, and carbon makes up the remaining 20%. Available casting solvents used in the slurry for non-porous polymeric substrates according to the present invention include both low and high boiling point solvents.

As used herein, “low boiling point solvents” typically have a boiling point below about 100° C. at atmospheric pressure (preferably around room temperature, e.g. 25-30° C.) and “high boiling point solvents” have a boiling point above about 100° C. or greater, preferably between about 100° C. and about 200° C. Suitable low boiling point solvents include, for example, relatively low boiling point organic solvents, such as alcohols including isopropanol, propanol, ethanol, methanol, and mixtures thereof. The most preferred casting solvents according to a preferred embodiment of the present invention include high-boiling point organic solvents. Useful alcohols include, for example, n-butanol, 2-pentanol, 2-octanol, and mixtures thereof, with n-butanol being particularly preferred. Other relatively high boiling point organic solvents useful with the present invention include, for example, butyl acetate. Further, as appreciated by one of skill in the art, the casting solvent may comprise water or water mixed with any of the hydrophilic low or high boiling point solvents at various concentrations to produce a solvent having a desired boiling point for the particular application.

A preferred embodiment of the present invention employs a high boiling point casting solvent in the slurry which is spread over a substrate. The substrate, in such an embodiment, is preferably a non-porous polymeric substrate. It has been observed that a slurry having a high boiling point solvent enhances the quality of the catalyst film formed on the substrate, in comparison with relatively low boiling point casting solvents. Although not limiting to principles by which the present invention operates, it is believed that because the higher boiling point solvents are vaporized at a more controlled and slower rate, the result is a more uniform drying of the coated slurry on the substrate, thus, providing enhanced physical integrity in the resulting decal. Typically, such vaporization is facilitated by processing with heat (and optionally vacuum). Decals produced according to preferred embodiments of the present invention, where the casting solvent is a high boiling point solvent, do not suffer from cracking and flaking of the decal from the substrate. The non-porous polymeric substrates according to the preferred embodiments of the present invention show a high compatibility with such high boiling point solvents used in the slurry and result in a higher quality of dried film. Further, high boiling point solvents are generally safer when handling and more environmentally friendly due to lower volatility.

The process next involves coating the catalyst slurry onto a surface of a substrate which has sufficient structural integrity to be reusable as indicated at 102. If a porous substrate is employed, often the solvent and ionomer in the slurry material is absorbed into the pores of the substrate. Such absorption results in an overall loss of ionomer from the decal. As recognized by one of skill in the art, when using a porous substrate material there is always some loss of the catalyst layer (e.g. slurry) into the pores, typically in the range of 15-25%. Thus, a porous substrate may absorb and remove catalyst ink slurry in unpredictable amounts. Therefore, modification of the catalyst composition to optimize performance characteristics is more easily achieved when using non-porous substrates, because of minimization of material loss and more predictable and reproducible results. Often, to compensate for the ionomer loss when using a porous substrate, an additional layer of ionomer is sprayed onto the decal after drying, to compensate for lost ionomer. The added ionomer layer is pressed into the decal during hot pressing, and compensates for the ionomer loss. As discussed, non-porous substrate materials according to the present invention substantially eliminate the loss of ionomer via absorption into the substrate, thus substantially eliminating the need to add additional ionomer layers. The present invention may provide more cost effective processing, by preventing loss of ionomer and additional processing steps.

As appreciated by one of skill in the art, a non-porous polymeric substrate has a negligible porosity that is substantially free of pores. The porosity of a material is preferably measured by a calculated weight difference measuring the amount of slurry absorbed in the substrate. The weight difference is calculated by measuring a first weight of the non-porous substrate prior to applying slurry to the substrate, and measuring a second weight of the substrate after the film has dried; been hot press transferred to the membrane; and then the substrate peeled away. The first weight is subtracted from the second weight, and then the percentage of weight difference from the first weight is calculated. A non-porous substrate according to the present invention preferably has a percentage weight difference of less than or equal to 3% of the first weight (preferably ranging between 0 to 3%), indicating only a small amount of catalyst has remained on the substrate.

Processes of making electrode assemblies using non-porous thin metallic sheets substrates, are disclosed in commonly assigned and owned U.S. patent application Ser. No. 10/171,295 filed on Jun. 13, 2002, however, in certain applications such a metallic substrate may experience bending and wrinkling during processing. The metallic sheet substrates may become permanently deformed, resulting in crinkles and possibly sharp protrusions that could potentially damage thin membranes or electrodes. Elastic deformation generally refers to non-permanent deformation (i.e. is totally recovered upon release of an applied stress). Plastic deformation is a permanent or non-recoverable deformation which occurs after the release of an applied load. In applications where wrinkling or bending potentially occurs, the non-porous substrate is selected to have elastic deformation properties (i.e. elasticity), so that significant deformations do not occur during processing that may impact the catalyst film (i.e. electrode) and/or the membrane. The non-porous polymeric substrates discussed above possess these favorable elastic deformation properties. Further, elastic non-porous polymeric substrates may prevent physical distortion or deformable stretching of the substrate during a separating or peeling step, where the catalyst film is removed from the substrate. These beneficial elastic properties of the non-porous polymeric material facilitate reuse of the substrate for subsequent decal applications.

In addition to flexible or supple elastic deformation properties, it is also desirable that the non-porous polymeric substrate according to the present invention has the following properties: chemical resistance, a minimum temperature resistance of at least about 160° C., and surface energies of from about 18 to about 41 dynes/cm. A surface energy value that is too high may prohibit or interfere with transfer of the catalyst film to the membrane, as where one that is too low results in a poor coating on the substrate. In another aspect, it is preferable to have a transparent non-porous polymeric substrate. Transparency of the substrate facilitates visual alignment of the decal to the membrane and other opposing decals during subsequent processing. The thickness of the non-porous polymeric substrate is preferably between about 12 to about 250 μm (from about 0.75 to about 10 mils), with preferred thicknesses ranging from about 12 to about 75 μm (from about 0.5 to about 10 mils). For handling and processing, it is also preferred that the dimensions of the substrate are greater than the area of the membrane during processing. Examples of suitable non-porous polymeric substrates according to the present invention may include: thermoplastic polymers such as, polyimide, polyphenylsulfone, and polytetrafluoroethylene (PTFE). A most preferred non-porous polymeric substrate is ethylene tetrafluoroethylene (ETFE), which has a surface energy of between about 25 to 28 dynes/cm, a temperature resistance of up to about 230° C., and a high degree of transparency.

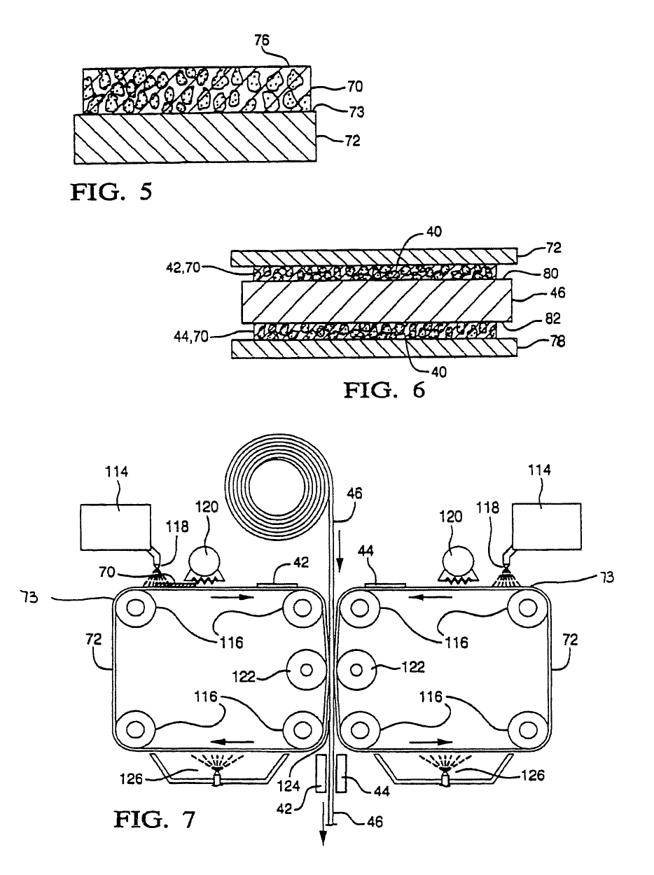

The prepared catalyst slurry is applied, or coated, onto the non-porous polymeric substrate 72 (FIG. 5) in accordance with step 102 (FIG. 4). For example, the catalyst slurry is spread onto a discrete region of a surface 73 of the substrate 72 in one or more layers and then dried at 104, where the casting solvent is substantially removed, to form a decal 70 with a preselected concentration of catalyst. The catalyst slurry is applied to the substrate 72 by any coating technique, for example, by printing processes or spray coating processes. Preferred processes are screen-printing or Mayer-rod coating. Mayer-rod coating, also known as coating with a metering rod, is well known in the art of screen printing or coating processes. Coatings with thicknesses ranging from 3 to 25 μm or higher are easily obtained and dried on the substrate by Mayer-rod coating. An enlarged cross-section of a dried catalyst layer decal 70 is illustrated on the substrate 72 in FIG. 5.

With continuing reference to FIG. 4, the catalyst layer 70 is dried, as indicated at 104. The layer 70 dries by vaporization of the solvent (i.e. high boiling point casting solvent) from the deposited catalyst slurry. Depending on the casting solvent (or mixtures of casting solvents) present in the slurry, the applied slurry is dried by removing solvent at temperatures ranging from above about 25° C. (room temperature) to below about 200° C. (where pressure is 1 atm). Vaporization of the high boiling point casting solvent preferably occurs between the preferred temperature range of 80° C. to 200° C., by application of heat and/or vacuum. Such methods of drying are well known in the art, and may include heat application by oven or infrared lamps, for example. As previously discussed, use of a higher boiling point casting solvent permits slower more controlled drying rates, which enhances the structural integrity of the decal 70. In one preferred embodiment, drying is alternatively undertaken in two steps. Immediately upon coating, the decal 70 is dried at about room-temperature for some period of time. Typically, this initial drying time is from about 1 to 3 minutes. Subsequently, the decal 70 may then be dried under infrared lamps or in an oven until virtually all the solvent has been eliminated. After the drying step 104, the decals 70 are weighed to determine the solids content. A homogeneous catalyst layer decal 70 as seen in FIG. 5, is then transferred on a surface 73 of the substrate 72 after the drying step 104.

As indicated at 106 of FIG. 4, the catalyst layers 70 are then bonded to the membrane 46, e.g., by hot-pressing at or above the glass transition temperature for the ionomer under elevated pressures, but below the glass transition temperature for the non-porous polymeric substrate (i.e. below the minimum temperature where the polymeric substrate will physically deform). At this temperature, which will generally range from about 70° C. to 160° C. at atmospheric pressure the ionomer (e.g., Nafion) begins to flow, and due to the pressure, disperses well throughout the porous structure formed and provides a satisfactory interface between the ionomer of the membrane 46 and ionomer 64 of the catalyst layer 70. Thus, by processing near or above the ionomer glass transition temperature, a good bond is formed between the electrode 70 and the membrane 46.

Referring to FIG. 6, the process preferably places a non-porous polymeric substrate 72 with a dried catalyst 70 anode layer 42 on one side 80 of the membrane 46 and a second non-porous polymeric substrate 78 with a dried catalyst 70 cathode layer 44 on the opposite side 82 of the membrane 46. Thus, in one embodiment, the hot-pressing preferably simultaneously applies both individual dried catalyst electrode layers 42, 44 to a first and second side, 80, 82, respectively of the membrane 46. These are typically called a decal transfer because the transfer process involves applying the dried catalyst layer 70, i.e. the electrode film 40 to a membrane 46. Alternatively, each decal 70 may be bonded to the membrane 46 sequentially, forming an assembly having one electrode 40.

The substrate(s) 72,78 are then separated or peeled from the dried catalyst layer 42,44 as indicated at 108 leaving a formed membrane electrode assembly 12 such as either of those illustrated in FIG. 2. The substrates 72,78 can be removed any time after hot-pressing. The substrates 72,78 may simply be removed or separated after permitting the substrates 72,78 to cool slightly. The substrates 72,78 preferably have a relatively low adhesion to the electrode 40, 70, based upon the surface energy previously discussed. This low adhesiveness ensures bonding of the electrode 40, 70 to the membrane 46 so that the substrates 72,78 will not effect the integrity of the interface between the electrode 40, 70 and the membrane 46 when they are removed. The formed membrane electrode assembly 12 is then taken off where it can be rolled up for subsequent use or immediately further incorporated into a fuel cell stack. The substrates 72,78 are then preferably cleaned using a solvent as indicated at 110.

The discrete regions of the substrate surface 73 (FIG. 5) where a film 70 was formed by the slurry mixture application, and then separated or removed by peeling, is cleaned simply by wiping or submerging the substrate 72 in a cleaning solvent between application of subsequent films. The solvent(s) preferably used to clean the substrate between uses are the same low boiling point solvents, previously discussed above, and include for example, low boiling point organic solvents and alcohols (boiling point below 100° C.) including: isopropanol, propanol, ethanol, methanol, water, and mixtures thereof. These solvents are typically less expensive than high boiling point solvents, and effectively clean the substrate for reuse. The substrate 72 is then provided for reuse as indicated at 112 (FIG. 4) and the catalyst slurry is again coated or applied onto the discrete regions of the substrate at 102. This process may be repeated many times over.

Referring to FIG. 7, a preferred continuous process embodiment is illustrated beginning with the slurry preparation station indicated at 114. As shown, the process utilizes two continuous strips of non-porous polymeric substrates 72 that can be selectively moved and advanced along respective feed paths. As shown in FIG. 7, the continuous strips of substrate 72 each travel a separate continuous feed path and are each provided as a continuous loop running around various rollers 116 in the direction indicated by the arrows. Thus, in the present embodiment both feed paths have the same sequence of stations, however the substrates 72 travel in opposite directions, hence, description of each processing station applies to both of the feed paths. At the coating stations 118 layer(s) of ink 70 are applied on the substrate 72. Preferably, the catalyst slurry or ink is pattern coated onto discrete regions on the surface 73 of the continuous strip of substrate 72. For example, the slurry may be spread using printing processes or spray coating processes as indicated above. The continuous strip substrate 72 having slurry applied on the discrete region advances along the feed path to drying station 120. At the drying station 120, the ink 70 is dried by removing casting solvent to form a dried catalyst layer 70. The drying station 120 preferably includes infrared drying lamps. In an alternative embodiment, the drying station has an oven and/or a vacuum chamber.

The discrete region having a dried catalyst layer 70 of the continuous strip of non-polymeric substrate 72 is advanced to a position adjacent to a roll of membrane 46. The roll of membrane 46 is provided centrally between the substrates 72 of both feed paths where the dried catalyst layer or decal 70 will be attached to the membrane 46 to form the electrodes 42, 44. The hot-pressing station 122 uses a pair of heated rollers to hot-press the electrodes 42, 44 (attached to the substrates 72 and arranged as seen in FIG. 6) onto both sides of the membrane 46. Alternatively, heated plates may be used in place of the rollers. Following hot-pressing, the substrate 72 is separated from the electrodes 42,44 (and attached membrane 46) at the removal station 124 created by turning the substrates 72 around the rollers 116 leaving behind the attached dried electrode film 42, 44 on both sides of the membrane 46.

An alternate preferred embodiment of the present invention provides a support member (not seen) on which the membrane 46 is selectively moved. The support member is preferably made of the same material as the substrate 72. The electrode decals 70 are spaced apart on the substrate 72 so that during a first hot pressing operation one side of the membrane 46 has a decal 70 bonded to it and the opposite side of the membrane 46 has the support member and blank substrate 72 pressing against it. Then the membrane 46 is transferred off of its support member to the substrate 72 as a result of being bonded to the decal. A second electrode decal 70 from the other substrate 72 is then located against the opposite side of the membrane 46 and bonded thereto by a second hot-pressing operation. Then, the substrates 72 are separated from the resulting membrane electrode assembly formed by this process, prior to being cleaned and returned to the coating station 118 for reuse.

The discrete region on the surface 73 where the decal 70 was removed on the continuous strip of substrate 72 then passes through a cleaning station 126 where the substrate is cleaned, e.g., sprayed with a cleaning solvent and then wiped clean to remove the solvent. Next, the substrate 72 returns to the pattern coating station 118 by passing around the rollers 116. Thus, the process as described above is repeated over again utilizing the same continuous strips of substrate 72.

The membrane electrode assembly 12 before separation of the non-porous substrate layers 72 appears as in FIG. 6. The assembly comprises the electrolyte membrane 46 with electrode decals 42, 44 on each side, and a support substrate material 72 along the opposite surface of each electrode 42, 44. The membrane electrode assembly 12 is formed by hot-pressing the non-porous substrate layers 72 and electrode decals 42,44, which forms a strong bond between the electrodes 42, 44 and the membrane 46. The substrate material 72 is removed before usage of the membrane electrode assembly 12 in the fuel cell 10. The procedure is applicable to anode 42 and cathode 44 fabrication in the making of an membrane electrode assembly 12.

As described above, the illustrated apparatus is capable of operation, for example, as a continuous or stepped process. A stepped process where the continuous strip of substrate 72 is selectively moved for processing, and may have intermittent starting and stopping. Further, the continuous strip of substrate 72 may be collected on reels and then reused. A continuous process is preferred where the substrate 72 is in a loop and advances continuously. For example, heated nip rollers as illustrated or alternative moving plates could be used to enable continuous movement of the substrate loops even during hot pressing operations.

Many other modifications to the above described embodiments may be made. For example, a single substrate 72 loop may be used with each side of the membrane 46 hot-pressed against different decals 70 of the same substrate 72. Thus, the first decal 42 could be peeled off before the second decal 44 is hot-pressed onto the opposite side of the membrane 46. Processing conditions for the non-porous polymeric substrate are performed at conditions similar to that used for traditionally-used (relatively expensive and non-reusable) porous expanded PTFE substrates.

The following is an example of a membrane electrode assembly prepared in accordance with the process described herein. A catalyst ink is prepared from a catalyst which preferably includes from about 20% to about 80% by weight Pt or Pt alloy supported on carbon which comprises the remaining weight percent. Specifically, a 50% Pt and 50% C catalyst is used in this example. In this case, 1 gram of 50 wt. % Pt supported on XC-72 Vulcan carbon commercially available from Tanaka is used.

This catalyst ink is mixed with 8 grams of 5 wt. % Nafion® solution designated as SE5112 which may be purchased from DuPont as the ionomer in this example. Flemion® which may be purchased form Asahi Glass, among others, may also be utilized as the ionomer. The ionomer solution casting solvent is composed of 60 wt. % water and 35 wt % low boiling point alcohols, such as, isopropanol. In addition, water and high boiling point alcohol (e.g. n-butanol) are added to the mixture to raise the total amount of water and high boiling point casting solvent in the mixture to about 30 wt. % of the solution and about 59 wt. % of the slurry mixture. This mixture, or slurry, is ball-milled for 24 hours before use. The result is the catalyst ink.

The catalyst ink is coated by a Mayer rod coating process onto a decal substrate which is a 2 mil thick sheet of ethylene tetrafluoroethylene (ETFE), commercially available from DuPont as Tefzel®. An appropriate Mayer rod size is used to obtain the desired thickness and subsequent catalyst loading. In this example, a Mayer rod number 80 is used, the dried catalyst layer is about 14 microns thick and the resulting catalyst loading is about 0.4 mg of Pt/cm².

After coating, the decal is heated by an infrared (IR) lamp at about 100° C. until most of the solvent has evaporated. In this example, this initial drying time is about 7 minutes. The decal can be fully dried in such an initial drying step, or alternately may include a further step where it is dried in an oven from about 5 minutes to about 10 minutes to evaporate any residual casting solvent. Data indicates that virtually no ionomer is absorbed into the non-porous polymeric substrate, and therefore, substantially all the ionomer in the ink gets transferred onto the membrane.

A decal fully formed and dried as described above is placed on each side of a polymer electrolyte membrane. The catalyst decal is arranged by visual alignment against the polymer electrolyte membrane and the non-porous polymeric substrates are outwardly exposed. In this example, the configuration is hot pressed at 400 psi, 145° C. for from about 4 minutes to about 8 minutes depending on size of membrane electrode assembly. For a 50 cm² membrane electrode assembly of this example, including decals of roughly equivalent size, the hot pressing operation is for about 4 to about 5 minutes.

The membrane electrode assembly is then allowed to cool down for about one minute at room temperature prior to separating or peeling the ETFE substrate from each side of the membrane electrode assembly. After removing the substrate, the catalyst film remains on each side of the membrane. Thus, a final membrane electrode assembly (MEA) is formed. This assembly is also referred to as a catalyst coated membrane (CCM). The substrate is then available for re-use in having other decals formed thereon.

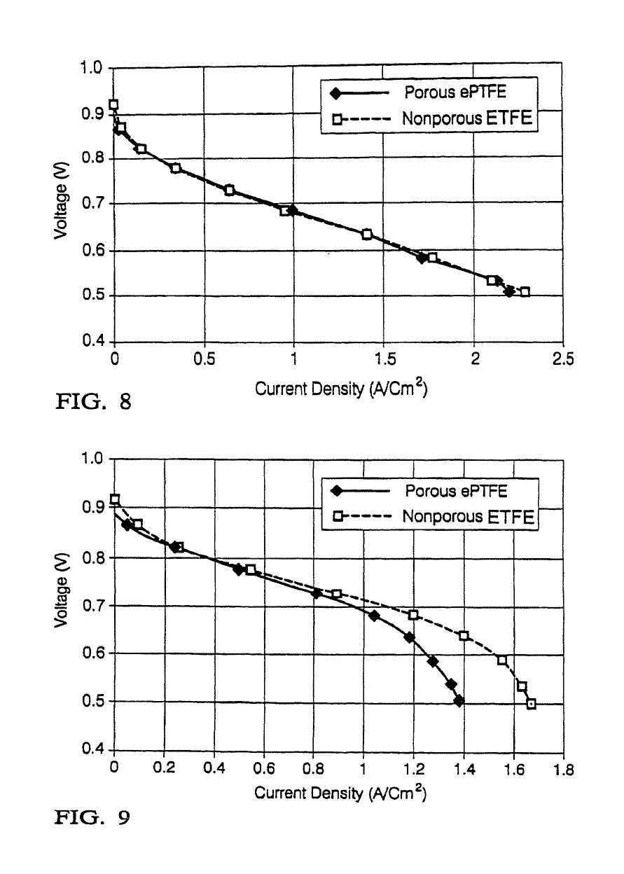

Comparative fuel cell performance data for MEAs is provided in FIGS. 8 and 9, comparing a MEA formed from a decal made according to a preferred embodiment of the present invention where a non-porous polymeric decal substrate (2 mil thick ETFE) is used versus a MEA made using an expanded polytetrafluoroethylene (ePTFE) decal substrate. FIG. 8 shows a low-pressure performance comparison of the MEAs, and FIG. 9 shows high-pressure performance comparison of the same MEAs. The MEA prepared with porous ePTFE was made with a spraying of additional ionomer on top of the catalyst coating before decal transfer. The MEA prepared with non-porous ETFE was prepared in the same manner as the porous ePTFE case except that no additional spraying was required (a further simplification benefit respective to the MEA fabrication process from non-porous polymeric substrate use). As shown in FIG. 8, the performance of the two MEAs is similar for stack pressures at 150 kPa. FIG. 9 shows that, at a higher stack pressure of 270 kPa, the non-porous substrate decal method demonstrates improved performance over the porous decal method. Both figures reflect air performance at 0.4/0.4 mg Pt/Cm² on a 1 mil membrane with cell temperature of 80° C., anode humidity at 100%, cathode humidity at 50%, and elemental hydrogen to air stoichiometric of 2/2.

There are several advantages to using a non-porous polymeric decal substrate material rather than other porous and non-porous substrates in a slurry electrode formation process. The non-porous polymeric substrate ensures that a well-dispersed catalyst ink coated onto the substrate will transfer completely after the hot press cycle. Further, non-porous polymeric substrates according to the present invention are compatible with high boiling point slurry solvents, which can be used to create high quality catalyst decals and electrodes. Other advantages of the non-porous substrates include elasticity or flexibility during processing that prevents physical deformities from forming and possibly harming the membrane or electrode; suitability for continuous web coating; durability and reusability; more streamlined production by elimination of additional steps, such as adding ionomer layers; enhanced economical production insofar as non-porous polymeric substrates are relatively inexpensive when compared to porous materials; and enhanced performance characteristics.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method of fabricating an assembly comprising an electrode in a continuous process comprising:
moving a continuous strip of a non-porous polymeric substrate along a feed path;
forming a slurry comprising an ionically conductive material, an electrically conductive material, a catalyst, and a casting solvent at a first station along said feed path;
advancing said continuous strip of said non-porous polymeric substrate to said first station;
applying said slurry at said first station to one or more discrete regions on a surface of said continuous strip of said non-porous polymeric substrate;
drying said slurry to form a film at each of said discrete regions;
advancing said continuous strip to position a membrane adjacent a respective one of said films at said discrete regions;
bonding said film to said membrane to form an electrode;
removing said electrode from said continuous strip;
advancing said continuous strip to a cleaning station to clean said discrete regions of said surface from which said electrode was removed; and
advancing said cleaned continuous strip of said substrate to said first station.

2. The method according to claim 1, wherein two continuous non-porous polymeric substrates move along two independent feed paths, and said advancing, applying, and drying occur simultaneously along said discrete regions of both of said continuous non-porous polymeric substrates forming a first and a second film, respectively, wherein said advancing of said discrete regions of both of said substrates positions said membrane between said first and second films, and wherein said bonding forms electrodes along two sides of said membrane.

2. The method according to claim 1, wherein said non-porous polymeric substrate comprises a polymer selected from the group consisting of: ethylene tetrafluoroethylene, polytetrafluoroethylene, polyimide, and polyphenylsulfone.

4. The method according to claim 1, wherein said slurry comprises water.

5. The method according to claim 1, wherein said casting solvent comprises an organic solvent.

6. The method according to claim 1, wherein said casting solvent has a boiling point greater than about 100° C.

7. The method according to claim 1, wherein said casting solvent is selected from the group consisting of: n-butanol, 2-pentanol, 2-octanol, butyl acetate, water, and mixtures thereof.

8. The method according to claim 1, wherein said bonding is accomplished by hot pressing at least one said film to said membrane and occurs at a temperature at or above the glass transition temperature of said ionomer, but below the glass transition temperature of said non-porous polymeric substrate.

9. The method according to claim 1, wherein said applying includes a coating process selected from the group consisting of: a printing and a spraying process.

10. The method according to claim 1, wherein said electrically conductive material comprises carbon and said catalyst comprises a metal.

11. The method according to claim 1, wherein said ionically conductive material is a perfluorosulfonate ionomer.

12. The method according to claim 1, wherein said cleaning is conducted with a solvent comprising an organic solvent.

13. The method according to claim 1, wherein said cleaning is conducted with a solvent selected from the group consisting of: propanol, isopropanol, ethanol, methanol, water, and mixtures thereof.
